(19) United States
(12) Patent Application Publication
(10) Pub. No.: US 2015/0111181 A1
(43) Pub. Date: Apr. 23, 2015

(54) COMPUTER IMPLEMENTED SYSTEM FOR LEARNING HISTORY

(71) Applicant: DANIEL L. GINSBERG, NEWPORT BEACH, CA (US)

(72) Inventor: DANIEL L. GINSBERG, NEWPORT BEACH, CA (US)

(21) Appl. No.: 14/588,389

(22) Filed: Dec. 31, 2014

(51) Int. Cl. G09B 19/00; G09B 7/00; G09B 5/00

(52) U.S. Cl. CPC G09B 19/0046; G09B 5/00; G09B 7/00
USPC 434/154

(57) ABSTRACT

A computer implemented system for learning history includes a historical module; and, a creative module. The historical module includes campaigns, each representing a time period. Each includes a number of defined mission modules, each including historical developments in an associated campaign. Upon completion of the mission module, the historical module provides the user with the next mission module. The process of completing missions and objectives is repeated until all missions are completed in a campaign. Essays are then presented at an end of an associated campaign, each comprising a model argument relating to the campaign. The historical module includes campaign quizzes for testing a user's comprehension of the campaign and the campaign essays. Each historical module presents each campaign quiz after each campaign essay. The creative module is then unlocked, providing play independent of historical fact. The score results of the campaign quiz determine an extent of creative play.

### BACKGROUND OF THE INVENTION

1. Field of the Invention

The present invention relates generally to computer based recreational and educational tools, and more particularly to a computer based system for learning history.

2. Description of the Related Art

Many students throughout the nation have a difficult time learning and comprehending advanced high school and university classes, such as AP European History and AP United States History. In this age of highly advanced technology and instant gratification, taking the time to study and grasp a fundamental understanding of concepts is difficult for students. Students are continually sidetracked from studying with myriad video games offered on the market. As will be discussed below in detail, the system of the present invention creates an environment for students to not only enjoy themselves via recreational gaming, but to also learn and understand fundamental concepts necessary for success on tests and essays.

The majority of video games currently offered on the market only cater to recreational gamers. For example, Activision's Call of Duty series only offers players with historical fiction, thus, the scope of learning is reduced, as the game is only played through the eyes of specific players in a semi-fictional environment. Although some of the games in the Call of Duty series may portray real historical battles, any type of educational aspects are hardly relevant to necessary concepts in history classes, as much of the discussion throughout the gameplay relates to weapons or specific battles which are not usually tested on in many educational environments, such as high school history classes.

Other video games integrate historical aspects throughout a fictional base. Firaxis' Civilization series includes historical developments, such as the development of fascism, communism, capitalism, and weaponry. The fundamental problems with actually applying educational knowledge from video games such as these include the fact that these games do not accurately place the historical aspects in chronological order, which is a necessary concept for success in an advanced placement course for history. For example, the Civilizations series may allow the player to advance far ahead other players, with modern infantry fighting against prehistoric barbarians. This is obviously not an accurate portrayal of historical developments.

Some other video games may offer users with an in-depth understanding of geography and military units of a time period, but fail to guide players to understand the real historical outcomes and ramifications that the geography and units played have throughout history. SEGA's Empire: Total War provides a stunning and graphically advanced map that may possibly offer players with an understand of the geography, ethnic background, religion, and territorial boarders of nations within Europe, part of the America's, part of Africa, and part of Asia, but the video game mostly fails to show the specific effects that these historical aspects play out in real history. Empire: Total War also provides players with sundry units that have actually appeared in history, but knowledge of such specific and detailed units is still irrelevant to the overall concepts needed for advanced history courses, as mentioned above.

### SUMMARY OF THE INVENTION

In an embodiment, the present invention is a computer implemented system for learning history. It includes a historical module; and, a creative module. The historical module includes a plurality of campaigns, each campaign representing a time period. Each campaign includes a plurality of defined mission modules, each mission module comprising historical developments in an associated campaign. Each mission module has at least one goal. Each mission module includes a plurality of objectives. Each objective is required to be completed to complete the mission module. Upon completion of the mission module the historical module is configured to provide a user with a next mission module. The process of completing missions and objectives therein is repeated until all missions are completed in a campaign. The historical module includes a plurality of campaign essays. Each of the campaign essays comprises a model argument relating to a prompt relative to the campaign. The historical module is configured to present a campaign essay at an end of an associated campaign. The historical module also includes a plurality of campaign quizzes for testing a user's comprehension of the campaign and the campaign essays. Each historical module is configured to present each campaign quiz after each campaign essay is presented to the user. The historical module generates score results upon completion of each campaign quiz. The computer implemented system for learning history also includes a creative module configured to be unlocked, providing play independent of historical fact, wherein the score results of the campaign quiz determine an extent of creative play.

In an embodiment, the present invention also includes a testing module engageable for a user to have access to a bank of testing module essays and testing module quizzes independently of play in the historical module and in the creative module.

In an embodiment, the invention is a method for learning history. The method includes the steps as follows: 1) A user is provided with the option to enter a campaign. The campaign represents a time period. 2) The user is provided with a first set of sequential objectives. The first set of sequential objectives collectively defines a first mission plurality of campaigns. The user is presented with plurality of sequential missions in a mission module. Each mission module has at least one goal. Each objective is required to be completed to complete the mission module. The process of completing missions and objectives therein is repeated until all missions are completed in a campaign. 3) The user is provided a campaign essay when a campaign is completed. The campaign essay comprises a model argument relating to a prompt relative to the campaign. 4) The user is provided with a campaign quiz when the essay is completed. The campaign quiz is for testing a user's comprehension of the campaign and the campaign essay, wherein the campaign quiz is presented after a defined period after the campaign essay is presented to the user. The historical module generates score results upon completion of each campaign quiz. 5) A creative module is unlocked. The creative module is accessed by the user upon completion of the campaign quiz, providing play independent of historical fact, wherein the score results of the campaign quiz determine an extent of creative play.

In an embodiment, the invention is a machine-readable non-transitory storage medium having instructions therein, which when executed by a processor in a machine, causes the machine to: a) provide a user with the option to enter a campaign, the campaign representing a time period; b) provide the user with a first set of sequential objectives, the first set of sequential objectives collectively defining a first mission plurality of campaigns, wherein the user is presented with plurality of sequential missions in a mission module, each mission module having at least one goal, wherein each objective is required to be completed to complete the mission module, wherein the process of completing missions and objectives therein is repeated until all missions are completed in a campaign; c) provide the user a campaign essay when a campaign is completed, the campaign essay comprising a model argument relating to a prompt relative to the campaign; d) provide the user with a campaign quiz when the campaign essay is completed, the campaign quiz being for testing a user's comprehension of the campaign and the campaign essay, wherein the campaign quiz is presented after a defined period after the campaign essay is presented to the user, the historical module generating score results upon completion of each campaign quiz; and, e) unlock a creative module to be accessed by the user upon completion of the campaign quiz, providing play independent of historical fact, wherein the score results of the campaign quiz determine an extent of creative play.

Unlike video games like Activision's Call of Duty series, Firaxis' Civilization series, and SEGA's Empire: Total War, the present inventive concepts provide defined objectives required to be completed to complete the mission module, required completion of missions and objectives therein being repeated until all missions are completed in a campaign, a historical module configured to present essays at the end of an associated campaign, and also provide quizzes after the essays are presented to the user which cooperate synergistically to provide a platform for enhanced learning of history. Utilization of the creative module provides a reward system for the user, emulating the creative and exciting components of the user experience in prior video games so that the user will continually be engaged in this process of learning history.

Other objects, advantages, and novel features will become apparent from the following detailed description of the invention when considered in conjunction with the accompanying drawings.

### BRIEF DESCRIPTION OF THE DRAWINGS

FIG. 1 is a schematic block diagram of the computer implemented system for learning history of the present invention.

FIG. 2A is an example of a display of the main menu showing the expanded “options” that are presented to the user.

FIG. 2B is an example of a display of the main menu showing the expanded single player options that are presented to the user.

FIG. 2C is an example of a display of gameplay during the “Capitalism” campaign, showing a window that presents the user with the mission goal and associated objectives.

FIG. 2D is an example of a display of gameplay during the “Capitalism” campaign, showing a window to the user that indicates that the first objective in the sequence of objectives for the specified mission has been completed, and presents the user with the next objective in the sequence of objectives.

FIG. 2E is an example of a display of gameplay during the “Capitalism” campaign, showing a window that presents the user with the next mission goal and associated objectives, making the inference that user has completed the mission shown in FIGS. 2C and 2D.

FIG. 2F is an example of a display of gameplay during the “Capitalism” campaign, showing a “pop-up” window regarding relevant information that the user can further educate himself for enhanced learning.

FIG. 2G is an example of a display of gameplay during the “Renaissance” campaign, showing an example prompt as well as the beginning of an essay related to the prompt, allowing the user to be further familiarized with the essay formatting needed for the AP Exam, as well as a countdown clock.

FIG. 2H is an example of a display of gameplay during the “WWI” campaign, showing example questions for a quiz, which will familiarize the user with sample multiple choice questions as well as a countdown clock.

FIG. 3 is a schematic block diagram illustrating an example of a suitable computing environment for the system of the present invention.

The same elements or parts throughout the figures of the drawings are designated by the same reference characters, while equivalent elements bear a prime designation.

### DETAILED DESCRIPTION OF THE INVENTION

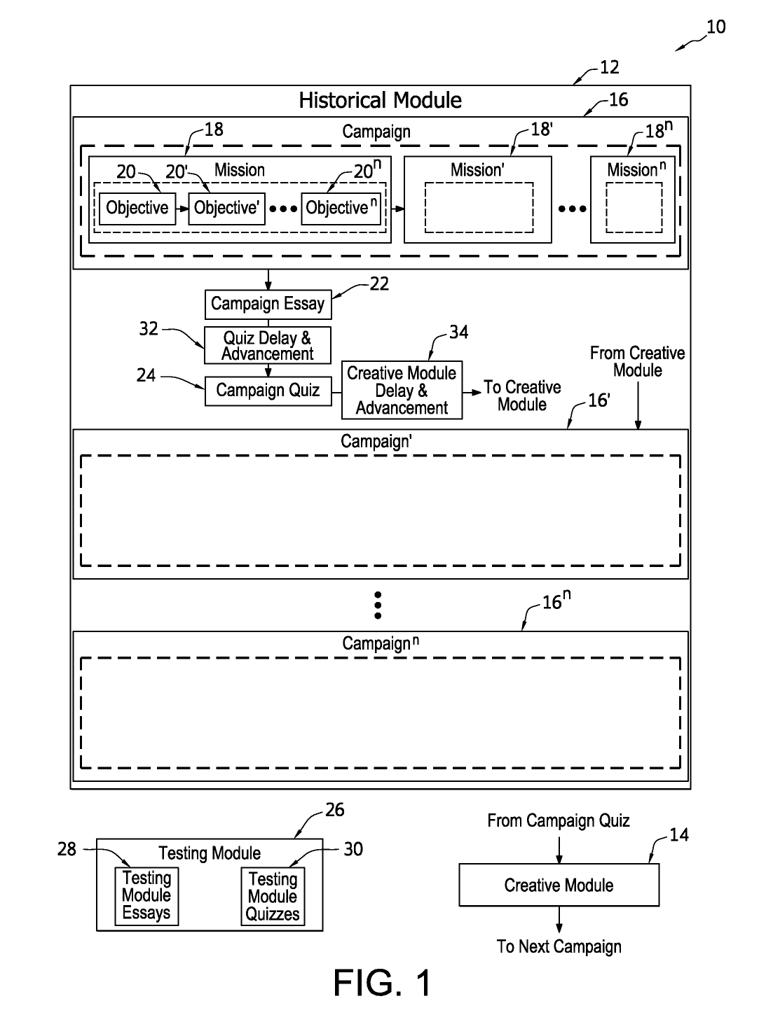

Referring now to the drawings and the characters of reference marked thereon, FIG. 1 illustrates the computer implemented system for learning history of the present invention, designated generally as 10. The computer implemented system 10 includes a historical module 12, a creative module 14, and a testing module 26. The historical module 12 includes accurate historical representations which are represented by a plurality of campaigns 16, 16′, . . . 16ⁿ, in which each campaign represents historical developments in a defined time period. For example, a campaign 16 may be the Renaissance period from the 1300s to the 1500s, whereas campaign 16′ may be the Protestant Reformation period beginning in the 1500s.

Each campaign 16, 16′, . . . 16ⁿ includes a number of defined mission modules 18, 18′, . . . 18ⁿ. Each mission module represents historical developments in an associated campaign. Mission modules 18, 18′, . . . 18ⁿ can also include political, economic, social, cultural, intellectual, and diplomatic goals. For example, a specific mission in the “World War II” campaign might be to liberate France.

Each mission module 18, 18′, . . . 18ⁿ includes a number of objectives 20, 20′, . . . 20ⁿ. Each objective may include political, economic, social, cultural, intellectual, and diplomatic goals. For example, a specific objective in the “World War II” campaign might be to have access to a certain amount of men to eventually execute the Normandy landings. Each objective within its respective mission module 18, 18′, . . . 18ⁿ is completed in order to advance to the next mission module.

Upon completion of a mission module 18 in a campaign, the historical module 12 provides the user with a succeeding mission module that includes objectives 20, 20′, . . . 20ⁿ, and this process repeats until all the missions are completed in a campaign 16. For example, upon completion of the specific mission to liberate France in the “World War II” campaign, the succeeding mission might be to gain enough resources to eventually invade Germany.

The historical module 12 provides a plurality of campaign essays 22 which includes prompts and fully written essays that directly correlate with campaigns 16, 16′, . . . 16ⁿ.

The historical module 12 presents a campaign essay 22 at the end of an associated campaign 16. The campaign essay includes a model argument relating to a prompt relative to the campaign 16, as well as a fully written response which effectively answers the model prompt with aspects that may include an explicit argument, specific evidence, analysis, as well as a conclusion.

The historical module 12 provides a plurality of campaign quizzes 24 which includes questions that directly correlate with the information presented in campaigns 16, 16′, . . . 16ⁿ. For example, the campaign quiz for the “World War II” campaign might cover the specific names of commanding generals, the ramifications of battles, major historical developments, etc.

The historical module 12 provides a campaign quiz 24 in order to test the user's comprehension of a campaign 16 as well as campaign essay 22.

The score resulting from the campaign quiz 24 determines the amount of time that the user has to play on the creative module 14. For example, if the user scores a 14/20 on his campaign quiz 24, he may receive 14 minutes to play on the creative module 14. If the user scores a 20/20 on his campaign quiz 24, he may receive 20 minutes to play on the creative module 14.

In other embodiments, the score resulting from the campaign quiz 24 may also not only determine the time that the user has to play on the creative module 14, but may also limit the amount of respective turns (should the system be configured to be “turn-based”), or any other limiting factor in the amount of time spent on the creative module 14.

The creative module 14 will provide play that is independent and overall absent of historical fact, but the creative module 14 will correspond with (i.e. share) the same physical characteristics as its corresponding campaign 16. These physical characteristics may include the same map area, the type of units that spawn, and the number of units that spawn. For example, campaign 16 may be the “World War II” campaign, and the historical module 12 may provide X number of German, Soviet, British, and American units. The campaign 16 may force the user to strategically use and move around these units, but the creative module 14 will not obligate the user to follow the traditional strategies provided in campaign 16 within the historical module 12. But within the creative module 14, the system 10 may spawn the same X number of German, Soviet, British, and American units, as well as limit the user to the same area in which the campaign 16 took place. Essentially, the creative module 14 is an emulation of the historical module 12, sharing the same map types, units, etc., except the creative module 14 does not include historical accuracies and is not intended to educate the user in any way.

As applied to AP European History, the system 10 preferably supplies information to the user from the time period of about 1300 to the present. This is the time period from which the AP European History class starts. In other embodiments, the system 10 may supply information to the user from any defined time period based on the subject matter of the course/class. For example, if the system 10 is configured for the AP World History course, the system 10 may supply information to the user from the ancient history to the present.

The system 10 further supplies a testing module 26 engageable for the user to have access to a bank of testing module essays 28 and testing module quizzes 30 independently of play from the historical module 12 and the creative module 14. For example, if the user desires to only view essays and quizzes in the same style as the campaign essays 22 and the campaign quizzes 24, the user has the option to open the testing module 26 without completing or entering the creative module 14 or the historical module 12.

The system 10 (via the historical module 12) preferably includes a quiz delay and advancement system 32 for delaying presentation of the campaign quiz until a predetermined period of time passes after the essay is presented, and the forced advancement of the campaign essay to the campaign quiz after a predetermined period of time passes. This quiz delay and advancement system 32 will allow the user to become more comfortable with being pressured under time to perform, which is an instrumental aspect of myriad exams, especially the AP History Exams offered by College Board. The user will be forced to move on to the campaign quiz, similar to a student taking the AP Exam moving from the multiple choice portion to the essay portion of the exam. The delay aspect encourages the user to continue to read and make mental notes, which is a key aspect to succeeding on myriad exams.

The system 10 (via the historical module 12) in other embodiments may also include a system for allowing the user to delay or advance presentation of the campaign quiz per their own discretion.

The system 10 (via the historical module 12) preferably includes a system wherein upon presentation of the campaign quiz, the user cannot return to view the campaign essay. This will allow the user to become more comfortable with not being able to reference information during the exam. The AP Exams will not allow the user to reference outside information during the actual exam.

The system 10 (via the historical module 12) preferably includes a system wherein upon completion of the campaign quiz, the creative module for the campaign that is associated with the quiz is unlocked and is able to be accessed at the user's convenience. By forcing the user complete the campaign quiz in order to unlock the arguably more enjoyable creative module, it is reinforcing the idea that hard work will eventually lead to results. In addition, the results and accuracy of the campaign quiz directly determine the extent of creative play.

The system 10 (via the historical module 12) preferably includes a creative module delay and advancement 32 for delaying presentation of the creative module until a predetermined period of time passes after the campaign quiz is presented, and the forced advancement from the campaign quiz after a predetermined period of time passes. This creative module delay and advancement system 32 will allow the user to become more comfortable with being pressured under time to perform, which is an instrumental aspect of myriad exams, especially the AP History Exams. The timed quiz portion is mirroring the timed multiple choice portion that is present on the AP History Exams. The delay aspect encourages the user to check their answers, which in an instrumental skill that can be applied to many exams.

Although the system of the invention has been described as having both a quiz and creative module delay and advancement systems, in other embodiments of the system, the quiz and creative module delay and advancement systems may involve delay, but not an advancement or advancement, but not a delay. Both the quiz and creative module delay and advancement system could also include a link that would immediately be presented, and would allow the user to immediately advance without either forced delay or forced advancement.

The system 10 (via the historical module 12) preferably includes, as will be discussed below, additional facts in the form of pop-ups during the campaign that provide information to allow the user to learn additional information regarding history. The pop-ups will display historical facts during the game, being prompted by actions taken by the user that will correspond with the time period, country, etc. This additional knowledge will eventually help assist the user in studying for their classes as well as associated exams.

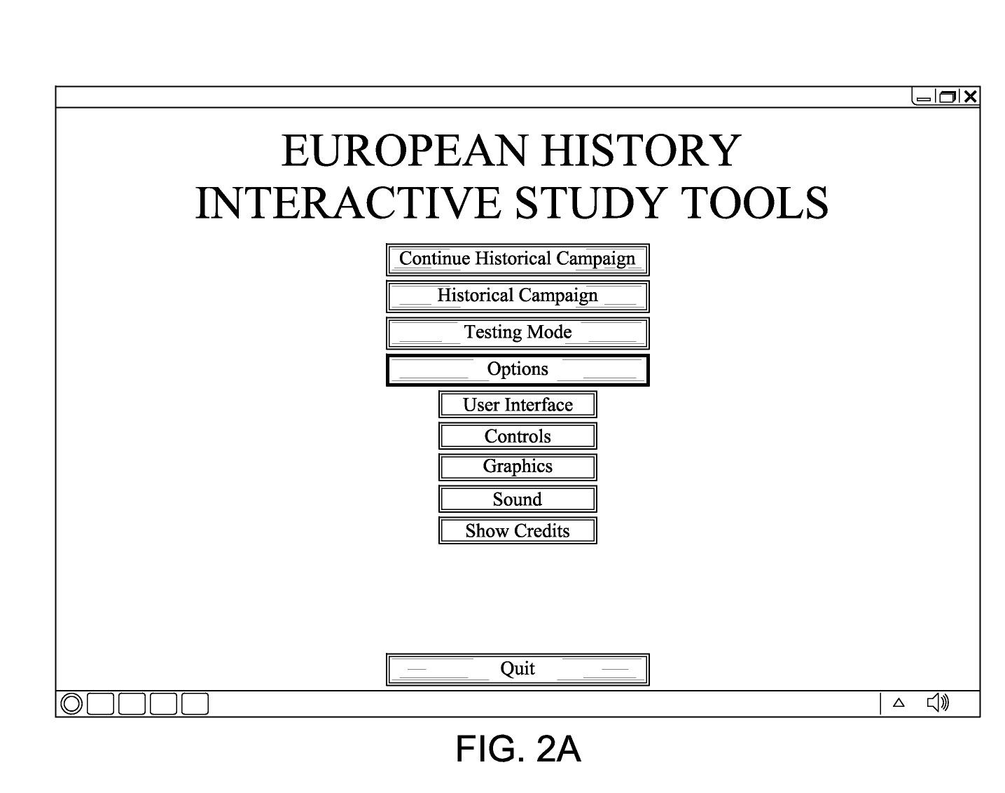

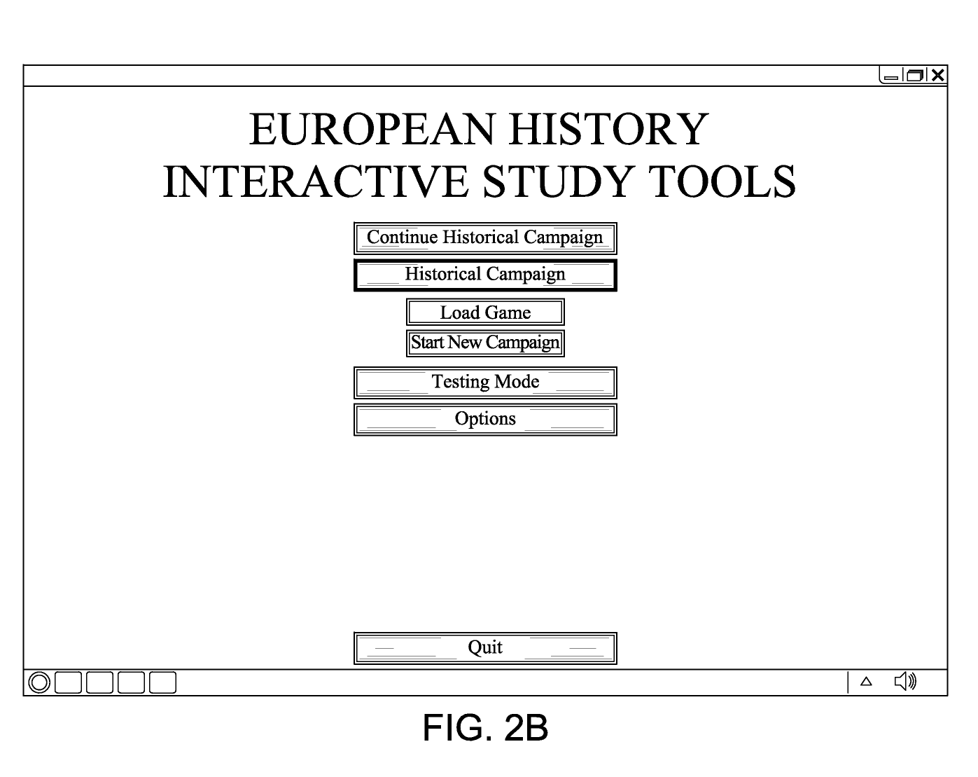

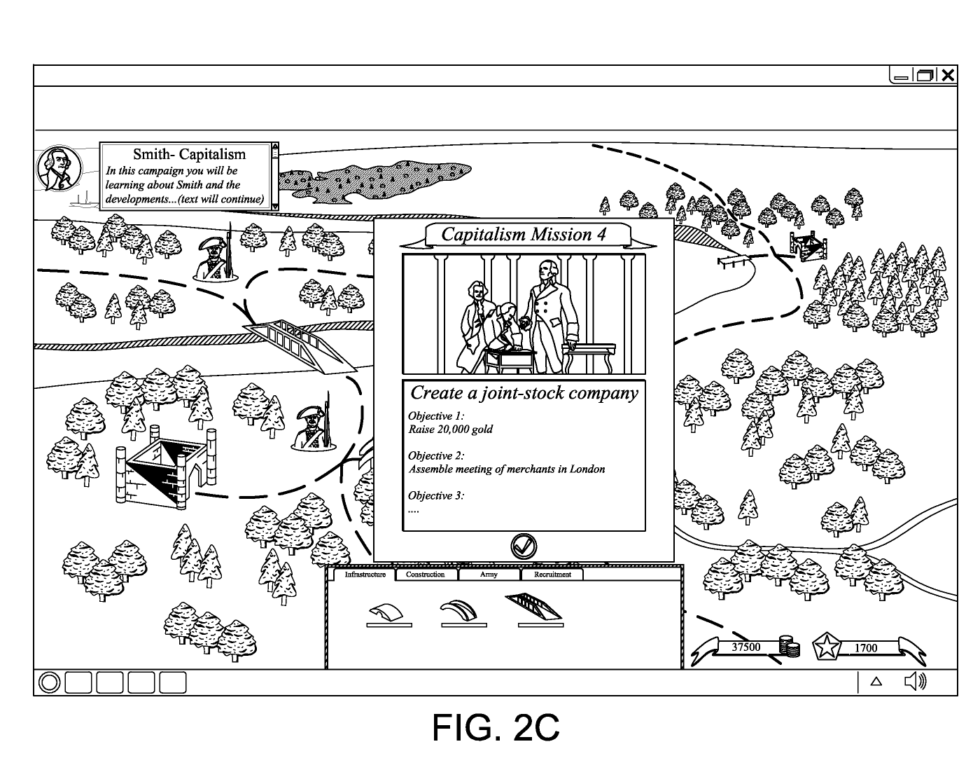

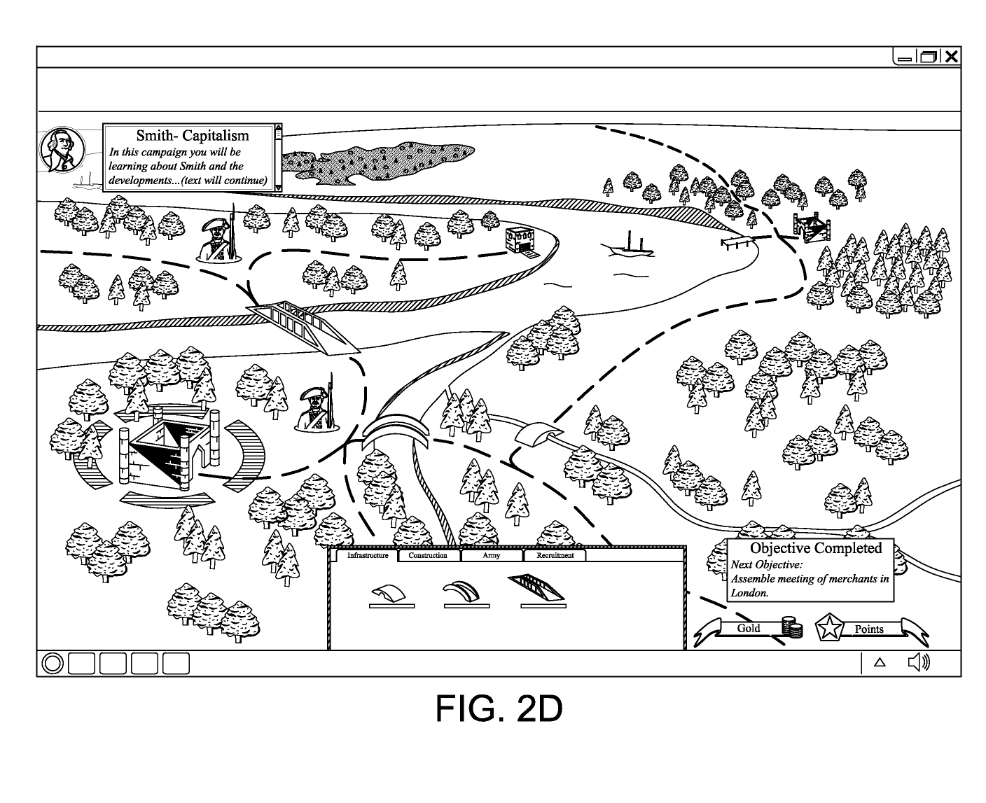

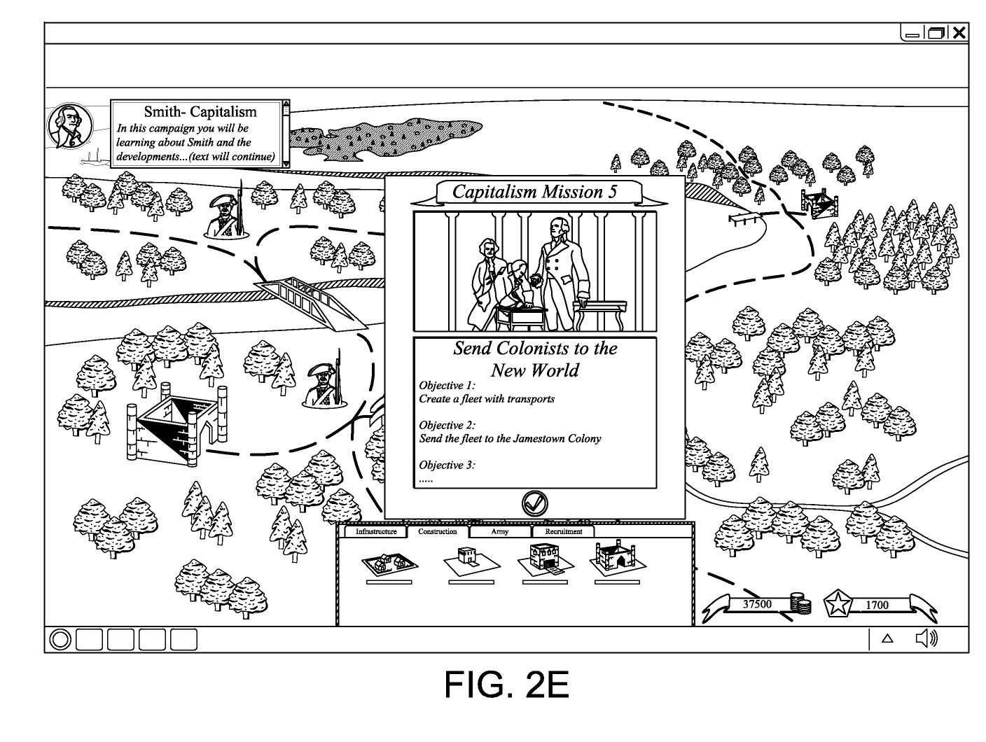

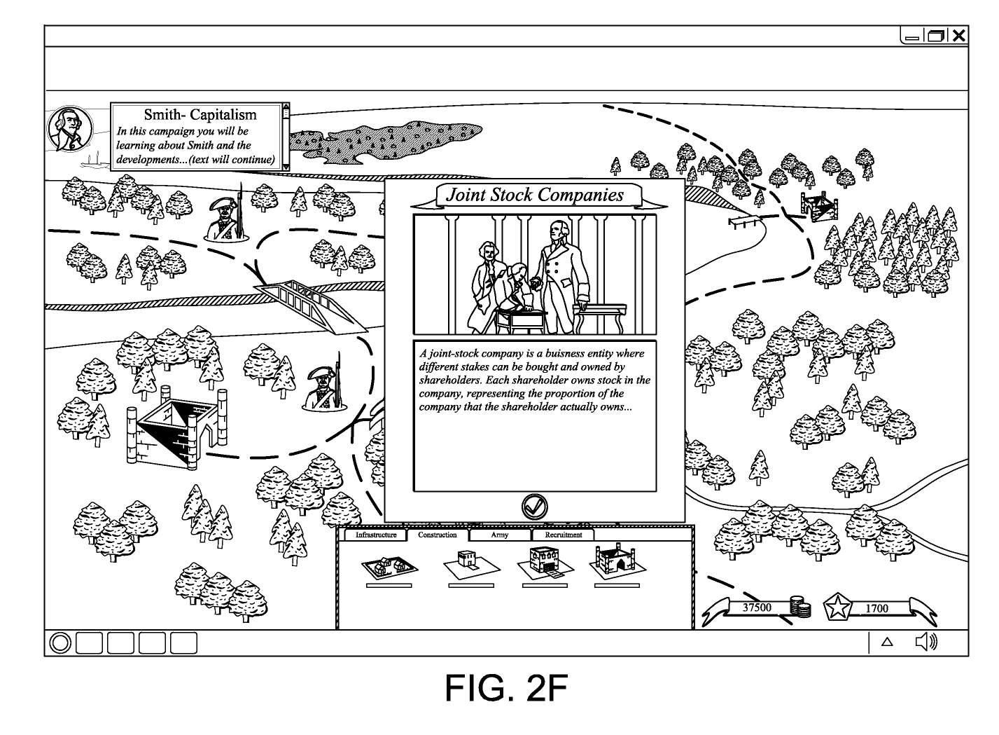

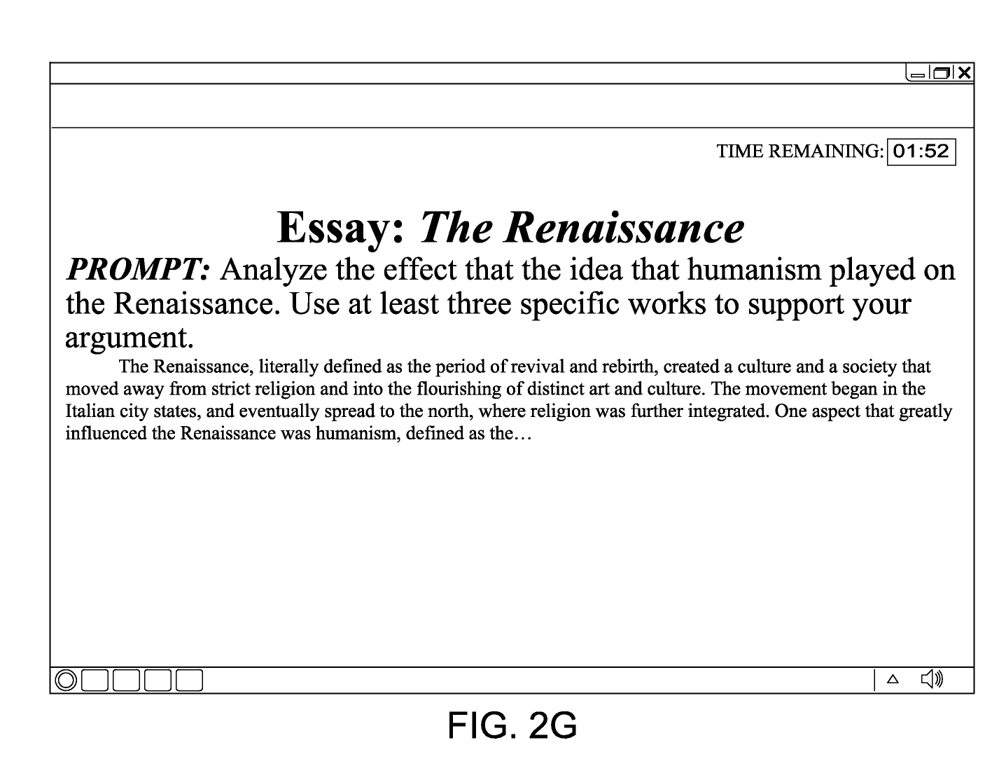

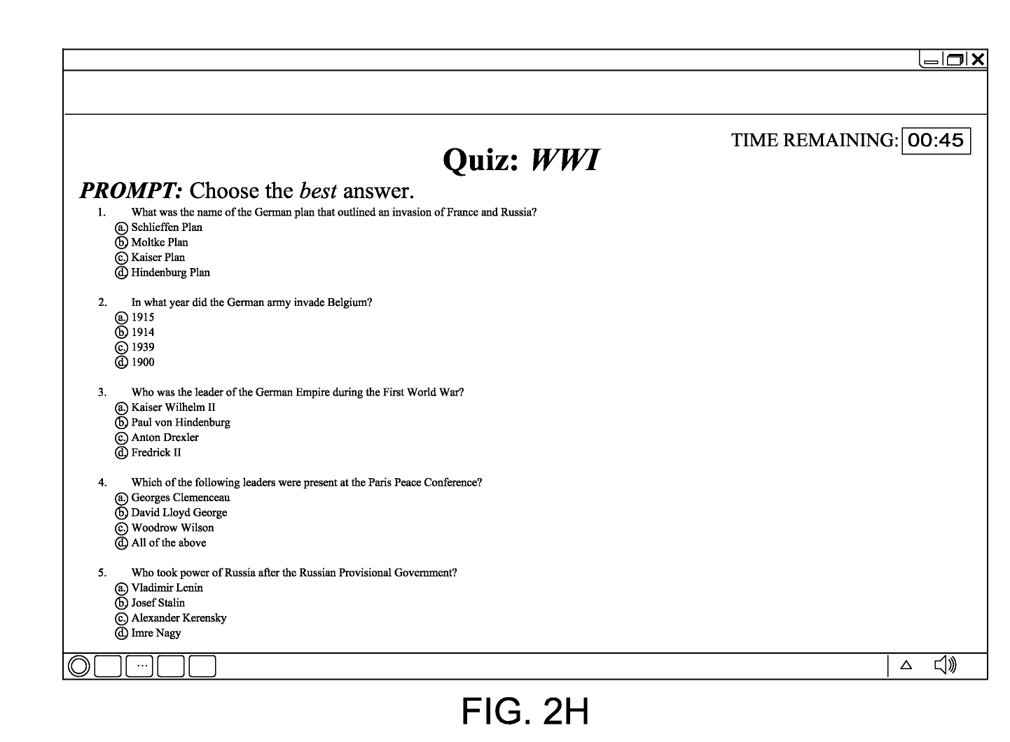

Referring now to FIG. 2A, in an example of operation, the system 10 has presented the user with a main menu, including various links to continue historical campaigns, begin a new historical campaign, or enter into the testing module 26. Other links include providing the ability to either access the options submenu (displayed in the figure) or to quit from the system 10. The options submenu may include access to graphics, sound, controls, user interface, and credits.

Referring now to FIG. 2B, in an example of operation, the system 10 has presented the user with a submenu upon clicking on the link labeled “Historical Campaign.” One of the two links included in the submenu are to “Load Game,” which refers to loading a game that the user has saved. The other link, “Start New Campaign,” refers to creating a new historical campaign for the user to interact with.

Referring now to FIG. 2C, in an example of operation, the user has resumed a previously saved historical campaign, and the system 10 (via the historical module 12), has presented the fourth mission within the campaign, which includes a variety of different objectives that should be completed in order to successfully complete the specified mission, and allow the system 10 (via the historical module 12) to present the user with another mission within the campaign, until all specified missions in the campaign are completed.

Referring now to FIG. 2D, in an example of operation, the system 10 (via the historical module 12), has presented the user with a window indicating that the previous objective has been completed, and a new objective has been presented, thus allowing the user to complete the next objective and further complete the mission, allowing him to further complete the campaign.

Referring now to FIG. 2E, in an example of operation, the system 10 (via the historical module 12), has presented the user with a window indicating that the previous mission has been completed, and the subsequent mission has been presented to the user, displaying a variety of different objectives that must be completed in order to successfully complete the specified mission, and allow the system 10 (via the historical module 12) to present the user with another mission within the campaign, until all specified missions in the campaign are completed.

Referring now to FIG. 2F, in an example of operation, the system 10 (via the historical module 12), has presented the user with a pop-up giving additional relevant information on the subject matter that the user is performing actions upon. This will further allow the user to understand the ramifications and relevance of his actions during gameplay, and further immerse the user in educational material. For example, if the user is currently in a campaign involving World War II, a relevant pop-up might include information regarding the D-DAY Landings, Operation Market Garden, or the Battle of Stalingrad.

Referring now to FIG. 2G, in an example of operation, the system 10 (via the historical module 12), has presented the user with a campaign essay about the topic that the user has recently completed the campaign for. The user should read the campaign essay until the amount of time given (as displayed on the countdown clock) has expired, to which point the user is forced to advance to the campaign quiz, but is not allowed to advance prior to time expiring, as outlined in the essay delay and advancement system. The campaign essay presented may be in a five paragraph form that can familiarize the user with the essay writing skills and formatting that will expected on the AP Exam. The essay may also include an explicit argument and claim, evidence to substantiate said claim, insightful analysis, and a conclusion.

Referring now to FIG. 2H, in an example of operation, the system 10 (via the historical module 12), has presented the user with a campaign quiz about the topic that the user has recently completed the campaign essay and the campaign for. The user participates in the quiz by choosing best answer choice from multiple choices. The quiz has the ability to familiarize and introduce a multiple choice format for the user to be exposed to before taking the AP Exam.

The campaign essay and campaign quiz shown in FIGS. 2G and 2H are also in the same format as the testing module quizzes and testing module essays, with a lack of campaigns preceding it. For example, if the user desires to familiarize himself with essays or quizzes regarding World War II, the user can enter the testing module and immediately enter into essays or quizzes. In the historical module, the campaign essays and quizzes come after the campaign, its associated missions, and objectives have been completed.

The system 10 via the campaign essay 22 or the testing module essay 28 may also include a “short answer” section that may deviate from the explicit essay format mentioned herein. The short answer section may include multiple photographs which will be presented to the user, wherein upon presentation of the photographs, the system 10 will present the user with short answer style formats that are similar to the essay format mentioned above. The “short answer” section may also include model prompts or explicit questions, where the system 10 will provide acceptable answers for the user in order to increase his overall knowledge of how to answer the short answer sections which may appear on the AP Exam.

Thus, in summary, the method for learning history in accordance with the present invention includes first providing a user with the option to enter a campaign. The campaign represents a time period. The user is then provided with a first set of sequential objectives. The first set of sequential objectives collectively defines a first mission plurality of campaigns. Eventually, the user is presented with plurality of sequential missions in a mission module, each mission module having at least one goal. Within each mission module is a plurality of objectives, each objectives being required to be completed to complete the mission module. The process described above is completed until all missions are completed in a campaign. After completion of the process described above, the user is then provided a campaign essay when a campaign is completed, and eventually a campaign quiz upon completion of the campaign essay. Upon completion of the campaign quiz, the system unlocks a creative module, wherein the score results of the campaign quiz determine the extent of creative play.

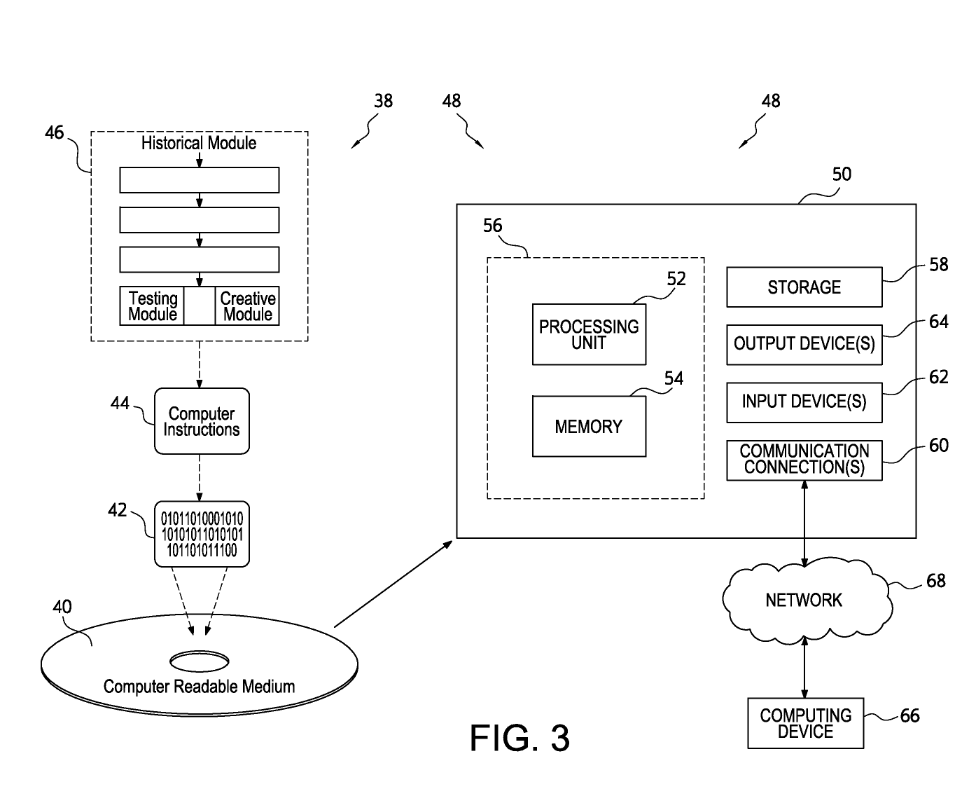

FIG. 3 and the following discussion provide a brief, general description of a suitable computing environment to implement embodiments of one or more of the provisions set forth herein. The operating environment of FIG. 3 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 3 illustrates the use of a computer-readable medium (i.e. machine-readable non-transitory storage medium) comprising processor-executable instructions configured to implement one or more of the techniques presented herein. A computer-readable medium that may be devised in these ways is illustrated in FIG. 3, wherein the implementation, designated generally as 38, comprises a computer-readable medium 40 (e.g., a CD-R, DVD-R, or a platter of a hard disk drive), on which is encoded computer-readable data 42. This computer-readable data 42 in turn comprises a set of computer instructions 44 configured to operate according to one or more of the principles set forth herein. In one such embodiment, the processor-executable computer instructions 44 may be configured to perform a method 46, such as at least some of the exemplary method illustrated in FIG. 1 and in FIGS. 2A-2H. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

FIG. 3 shows an example of a computing system 48 comprising a computing device 50 configured to implement one or more embodiments provided herein. In one configuration, computing device 50 includes at least one processing unit 52 coupled with memory 54. Depending on the exact configuration and type of computing device, memory 54 may be volatile (such as RAM, for example), non-volatile (such as ROM, flash memory, etc., for example) or some combination of the two. This configuration is illustrated in FIG. 3 by dashed line 56.

In other embodiments, device 50 may include additional features and/or functionality. For example, device 48 may also include additional storage (e.g., removable and/or non-removable) including, but not limited to, magnetic storage, optical storage, and the like. Such additional storage is illustrated in FIG. 3 by storage 58. In one embodiment, computer readable instructions to implement one or more embodiments provided herein may be in storage 58. Storage 58 may also store other computer readable instructions to implement an operating system, an application program, and the like. Computer readable instructions may be loaded in memory 54 for execution by processing unit 52, for example.

The term “computer readable media” as used herein includes computer storage media. Computer storage media includes volatile and nonvolatile, removable and non-removable media implemented in any method or technology for storage of information such as computer readable instructions or other data. Memory 54 and storage 58 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 50. Any such computer storage media may be part of device 50.

Device 50 may also include communication connection(s) 60 that allows device 50 to communicate with other devices. Communication connection(s) 60 may include, but is not limited to, a modem, a Network Interface Card (NIC), an integrated network interface, a radio frequency transmitter/receiver, an infrared port, a Universal Serial Bus (USB) connection, or other interfaces for connecting computing device 50 to other computing devices. Communication connection(s) 60 may include a wired connection or a wireless connection. Communication connection(s) 60 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 50 may include input device(s) 62 such as keyboard, mouse, pen, voice input device, touch input device, infrared cameras, video input devices, and/or any other input device. Output device(s) 64 such as one or more displays, speakers, printers, and/or any other output device may also be included in device 50. Input device(s) 62 and output device(s) 64 may be connected to device 50 via a wired connection, wireless connection, or any combination thereof. In one embodiment, an input device or an output device from another computing device may be used as input device(s) 62 or output device(s) 64 for computing device 50.

Components of computing device 50 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of computing device 50 may be interconnected by a network. For example, memory 54 may be comprised of multiple physical memory units located in different physical locations interconnected by a network.

Those skilled in the art will realize that storage devices utilized to store computer readable instructions may be distributed across a network. For example, a computing device 66 accessible via a network 68 may store computer readable instructions to implement one or more embodiments provided herein. Computing device 50 may access computing device 66 and download a part or all of the computer readable instructions for execution. Alternatively, computing device 50 may download pieces of the computer readable instructions, as needed, or some instructions may be executed at computing device 50 and some at computing device 66.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Computing device 50 may be configured to communicate with network 66 and or objective data services using a variety of communication protocols. The communications protocols may include but are not limited to wireless communications protocols, such as Wi-Fi, Bluetooth, 3G, 4G, RFID, NFC and/or other communication protocols. The communications protocols may comply and/or be compatible with other related Internet Engineering Task Force (IETF) standards.

The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006; ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or related and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

Computing device 50 may be configured to communicate with network 68 and or objective data services using a selected packet switched network communications protocol. One exemplary communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, computing device 50 may be capable of communicating with a network 68 using an X.25 communications protocol. The X.25 communications protocol may comply or be compatible with a standard promulgated by the International Telecommunication Union-Telecommunication Standardization Sector (ITU-T). Alternatively or additionally, computing device 50 may be configured to communicate with network 68 and or objective data services, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, computing device 50 may be configured to communicate with network 68 and or objective data services, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein. “Circuitry”, as used in any embodiment herein, may comprise, for example, singly or in any combination, hardwired circuitry, programmable circuitry, state machine circuitry, and/or firmware that stores instructions executed by programmable circuitry. An application (“app”) and/or module, as used in any embodiment herein, may be embodied as circuitry. The circuitry may be embodied as an integrated circuit, such as an integrated circuit chip.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

Although the above discussion describes the invention as being applicable to the AP European History course, the invention mentioned herein may also be easily adaptable to further serve any history course, such as AP United States History, AP World History, etc.

Although the above discussion describes the invention as being applicable to a chronological based history course, the invention mentioned herein may also be easily adaptable to further serve any history course, regardless of specific chronology or a lack thereof. That being mentioned, the campaign mentioned above must be chronologically based, not necessarily making the plurality of campaigns in a specific chronological order. For example, a campaign involving the industrial revolution may start in 1790, eventually proceeding to 1791, 1792, 1793, and so forth. The proceeding campaign might be regarding social changes in European households, starting in 1750, eventually proceeding to 1751, 1752, 1753, and so forth.

1. A computer implemented system for learning history, comprising:
a) a historical module, comprising;
i) a plurality of campaigns, each campaign representing a time period, each campaign comprising:
a plurality of defined mission modules, each mission module comprising historical developments in an associated campaign, each mission module having at least one goal, each mission module, comprising a plurality of objectives, each objective being required to be completed to complete the mission module;
wherein upon completion of the mission module said historical module is configured to provide a user with a next mission module, wherein the process of completing missions and objectives therein is repeated until all missions are completed in a campaign,
ii) a plurality of campaign essays, each of said campaign essays comprising a model argument relating to a prompt relative to said campaign,
wherein said historical module is configured to present a campaign essay at an end of an associated campaign,
iii) a plurality of campaign quizzes for testing a user's comprehension of said campaign and said campaign essays, wherein said historical module is configured to present each campaign quiz after each campaign essay is presented to the user, said historical module generating score results upon completion of each campaign quiz; and,
b) a creative module configured to be unlocked, providing play independent of historical fact, wherein the score results of said campaign quiz determine an extent of creative play.

2. The computer implemented system of claim 1, wherein said time period is about 1300 to the present.

3. The computer implemented system of claim 1, wherein said historical module comprises a quiz delay and advancement system for delaying presentation of said campaign quiz until a predetermined period of time passes after the campaign essay is presented, and a forced advancement from said campaign essay to said campaign quiz after a predetermined period of time passes.

4. The computer implemented system of claim 3, wherein upon presentation of said campaign quiz the user cannot return to view said campaign essay.

5. The computer implemented system of claim 1, wherein upon completion of said campaign quiz, said creative module for said campaign that is associated with said campaign quiz is unlocked and is able to be accessed at a user's convenience.

6. The computer implemented system of claim 1, wherein said historical module comprises a creative module delay and advancement system for delaying presentation of said creative module until a predetermined period of time passes after the campaign quiz is presented, and a forced advancement from said campaign quiz after a predetermined period of time passes.

7. The computer implemented system of claim 1, further comprising a testing module engageable for a user to have access to a bank of testing module essays and testing module quizzes independently of play in said historical module and said creative module.

8. The computer implemented system of claim 1, wherein upon completion of said campaign quiz for each campaign, said creative module shares the same physical characteristics as said campaign, except with an absence of historical fact.

9. The computer implemented system of claim 1, further comprising additional facts in a form of pop-ups during the campaign that provide information to allow a user to learn additional information regarding history.

10. The computer implemented system of claim 1, comprising:
a) a memory configured to store executable instructions configured in accordance with the historical module and said creative module; and,
b) a processor operatively coupled to the memory to execute the instructions from the memory, the processor being configured to implement said historical and creative module.

11. A method for learning history, comprising:
a) providing a user with the option to enter a campaign, said campaign representing a time period;
b) providing the user with a first set of sequential objectives, said first set of sequential objectives collectively defining a first mission plurality of campaigns, wherein the user is presented with plurality of sequential missions in a mission module, each mission module having at least one goal,
wherein each objective is required to be completed to complete the mission module, wherein the process of completing missions and objectives therein is repeated until all missions are completed in a campaign;
c) providing the user a campaign essay when a campaign is completed, the campaign essay comprising a model argument relating to a prompt relative to the campaign;
d) providing the user with a campaign quiz when the essay is completed, the campaign quiz being for testing a user's comprehension of the campaign and the campaign essay, wherein the campaign quiz is presented after a defined period after the campaign essay is presented to the user, said historical module generating score results upon completion of each campaign quiz; and,
e) unlocking a creative module to be accessed by the user upon completion of the campaign quiz, providing play independent of historical fact, wherein the score results of the campaign quiz determine an extent of creative play.

12. The method of claim 11, wherein said time period is about 1300 to the present.

13. The method of claim 11, wherein said historical module comprises a quiz delay and advancement system for delaying presentation of said campaign quiz until a predetermined period of time passes after the campaign essay is presented, and a forced advancement from said campaign essay to said campaign quiz after a predetermined period of time passes.

14. The method of claim 11, wherein upon presentation of said campaign quiz the user cannot return to view said campaign essay.

15. The method of claim 11, wherein upon completion of said campaign quiz, said creative module for said campaign that is associated with said campaign quiz is unlocked and is unlocked and is able to be accessed at a user's convenience.

16. The method of claim 11, wherein said historical module comprises a creative module delay and advancement system for delaying presentation of said creative module until a predetermined period of time passes after the campaign quiz is presented, and a forced advancement from said campaign quiz after a predetermined period of time passes.

17. The method of claim 11, further comprising a testing module engageable for a user to have access to a bank of testing module essays and testing module quizzes independently of play in said historical module and said creative module.

18. The method of claim 11, wherein upon completion of said campaign quiz for each campaign, said creative module shares the same physical characteristics as said campaign, except with an absence of historical fact.

19. The method of claim 11, further comprising additional facts in a form of pop-ups during the campaign that provide information to allow the user to learn additional information regarding history.

20. A machine-readable non-transitory storage medium having instructions therein, which when executed by a processor in a machine, causes the machine to:
a) provide a user with the option to enter a campaign, said campaign representing a time period;
b) provide the user with a first set of sequential objectives, said first set of sequential objectives collectively defining a first mission plurality of campaigns, wherein the user is presented with plurality of sequential missions in a mission module, each mission module having at least one goal,
wherein each objective is required to be completed to complete the mission module, wherein the process of completing missions and objectives therein is repeated until all missions are completed in a campaign;
c) provide the user a campaign essay when a campaign is completed, the campaign essay comprising a model argument relating to a prompt relative to the campaign;
d) provide the user with a campaign quiz when the campaign essay is completed, the campaign quiz being for testing a user's comprehension of the campaign and the campaign essay, wherein the campaign quiz is presented after a defined period after the campaign essay is presented to the user, said historical module generating score results upon completion of each campaign quiz; and,
e) unlock a creative module to be accessed by the user upon completion of the campaign quiz, providing play independent of historical fact, wherein the score results of the campaign quiz determine an extent of creative play.
